(19) United States
(12) Patent Application Publication
(10) Pub. No.: US 2009/0049498 A1
(43) Pub. Date: Feb. 19, 2009

(54) Method to Extend HDMI and DVI Connections over Long Distances

(76) Inventor: Changrong Li, Austin, TX (US)

Correspondence Address: Changrong Li, 10710 Cassia Dr., Austin, TX, 78759, US

(21) Appl. No.: 12/189,109

(22) Filed: Aug. 8, 2008

Related U.S. Application Data
(60) Provisional application No. 60/956,684, filed on Aug. 18, 2007.

(51) Int. Cl. H04N 7/173

(52) U.S. Cl. 725/127

(57) ABSTRACT

This invention is to use standard and very popular UTP (Unshielded Twisted Pair) cables, such as CAT-5, CAT-6 and CAT-7 cables to extend the original high-definition digital audio/video signals over long distance between HDMI/DVI compliant sources and HDMI/DVI compliant displays. It can be either an extension between one source and one display, or a distribution between one source and multiple displays.

This application claims the benefits of U.S. Provisional Application No. 60956684, filed on the 18^{th} day of Aug. 2007.

### FIELD OF THE INVENTION

The present invention relates to the transport of the high-definition video/audio from a source to one or more display(s).

### BACKGROUND OF THE INVENTION

HDMI and/or DVI are designed to transmit all-digital, uncompressed high-definition video/audio data over HDMI and/or DVI cables in real time. Due to their high bandwidth requirement, the transmission distance is limited. One way to transmit digital video data over long distances is to compress the video/audio content and thus greatly reduce the bandwidth requirement. Once this is done, the data can be transmitted over data networks such as the IP network. The following patent applications address various aspects of compressed video/audio content transmission over data networks.
US20060242669
Display node for use in an audiovisual signal routing and distribution system.
US20060117371
Method for effectively implementing a multi-room television system.
US20070103204
Method and apparatus for conversion between quasi-differential signaling and true differential signaling.

One drawback is that the video/audio quality is usually degraded during compression and decompression. In addition, it is usually costly to implement high ratio compression.

Another way to accomplish this task is to transmit the original signal over different cables or media such as optical fiber or Shielded Twisted Pairs (STP). Optical fibers are the ideal media for carrying the original video signals over long distances, but due to their high cost, they are only used for high-end equipment. STP cables are relatively cheaper compared to optical fibers, but they are still expensive to deploy. UTP cables cost much less and are the most commonly available, much easier to deploy communication media used in standard building infrastructure.

### SUMMARY OF THE INVENTION

The present invention is the use of Unshielded Twisted Pairs (UTP) to transmit all-digital, high-definition video/audio data between HDMI and/or DVI devices. Compared to STP, UTP cable is much cheaper and easier to install; more importantly, it can use the existing cable pre-routed in most buildings.

### BRIEF DESCRIPTION OF THE DRAWINGS

FIG. 1 shows one typical point-to-point application of an embodiment of the present invention in which one video source is extended to one display over one or two UTP cable/cables.

FIG. 2 depicts one typical point-to-multi-point application of an embodiment of the present invention in which one video source is extended to multiple displays over UTP cables.

FIG. 3 illustrates one typical point-to-multi-point application of an embodiment of the present invention in which one video source is extended to multiple displays over UTP cables through a distributor.

### DETAILED DESCRIPTION

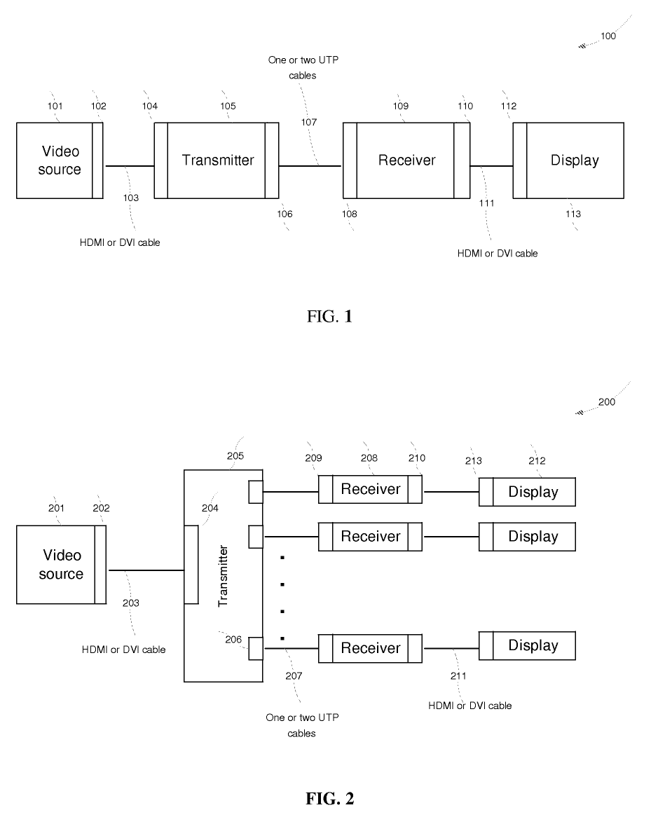

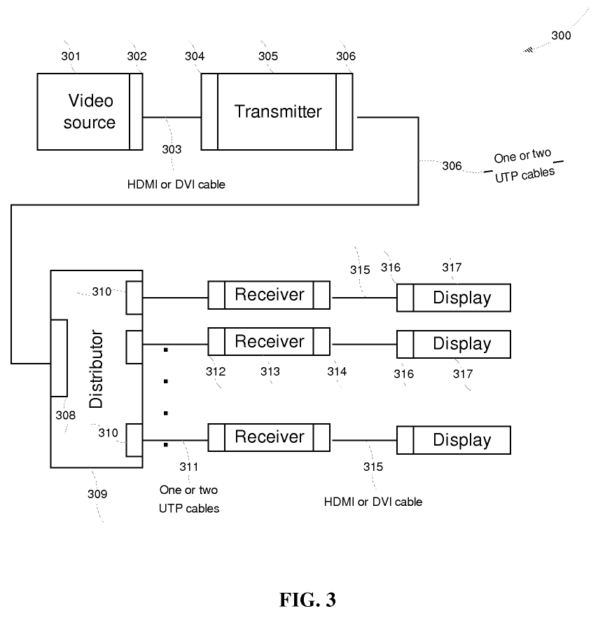

In FIG. 1, video source 101 is connected with HDMI or DVI connector 102 as the video output port. Typically, the source is the DVD player, HD DVD player, Blu-ray player, cable TV set-top box, satellite TV set-top box or computer.

The proper cable 103 matches the video port 102 on the video source 101 and the video port 104 on the transmitter 105. Typically, the proper cable 103 is a straight HDMI cable, straight DVI cable, HDMI to DVI adapter cable, or DVI to HDMI adapter cable.

The transmitter 105 based on the present invention includes the drivers/receivers and/or signal converters needed to transmit and receive the digital video and control signals over UTP cable/cables 107. Typically, it has a HDMI or DVI (depending on the targeted applications) connector 104 as a video and control signals input and output port, and one or two RJ45 UTP connect/connectors 106 as video and control signals output and input port/ports.

The UTP cable or cables 107 are usually one or two CAT-5, CAT-6, CAT-7 or other special UTP cable/cables.

The receiver 109 based on the present invention includes the drivers/receivers and/or signal converters needed to transmit and receiver the digital video signals and control signals over UTP cable or cables 107. Typically, the receiver 109 has one or two RJ45 UTP connector/connectors 108 as video and control signals input and output ports, and a HDMI or DVI (depending on the targeted applications) connector 110 as a video and control signals input and output port 113.

The proper cable 111 matches the video port 112 on the display 113 and the video port 110 on the receiver 109. Typically, the cable 111 is a straight HDMI cable, straight DVI cable, HDMI to DVI adapter cable, or DVI to HDMI adapter cable.

The display 113 is to display the target application, such as video. Typically, the display is a HDTV, including LCD TV, Plasma TV, and DLP TV, or computer monitor, including LCD display and other flat-panel displays.

In FIG. 2, the video source 201 is connected with HDMI or DVI connector 202 as the video output port. Typically, the video source 201 is a DVD player, HD DVD player, Blu-ray player, the cable TV set-top box, satellite TV set-top box or computer.

The proper cable 203 matches the video port 202 on the video source 201 and the video port 204 on the transmitter 205. Typically, the cable 203 is a straight HDMI cable, straight DVI cable, HDMI to DVI adapter cable, or DVI to HDMI adapter cable.

The transmitter 205 based on the present invention includes the drivers/receivers and/or signal converters needed to transmit and receive the digital video and control signals over UTP cable or cables 207. Typically, it has a HDMI or DVI (depending on the targeted applications) connector 204 as a video and control signals input and output port, and multiple RJ45 UTP connectors 206 as video and control signals output and input ports.

The UTP cable or cables 207 are usually one or two CAT-5, CAT-6, CAT-7 or other special UTP cable/cables.

The receiver 208 based on the present invention includes the drivers/receivers and/or signal converters needed to transmit and receive the digital video and control signals over UTP cable or cables 207. Typically, the receiver has one or two RJ45 UTP connector/connectors 209 as video and control signals input and output ports, and a HDMI or DVI (depending on the targeted applications) connector 210 as a video and control signals input and output.

The proper cable 211 matches the video port 213 on the display 212 and the video port 210 on the receiver 208. Typically, the proper cable 211 is a straight HDMI cable, straight DVI cable, HDMI to DVI adapter cable, or DVI to HDMI adapter cable.

The display 212 is to display the target application, such as video. Typically it is a HDTV, including LCD TV, Plasma TV, and DLP TV, or computer monitor, including LCD display and other flat-panel displays.

The video source 301 has a HDMI or DVI connector 302 as its video output port. Typically, the video source 301 is a DVD player, HD DVD player, Blu-ray player, the cable TV set-top box, satellite TV set-top box or computer.

The proper cable 303 matches the video port 302 on the video source 301 and the video port 304 on the transmitter 305. Typically, the cable 303 is a straight HDMI cable, straight DVI cable, HDMI to DVI adapter cable, or DVI to HDMI adapter cable.

The transmitter 305 based on the present invention includes the drivers/receivers and/or signal converters needed to transmit and receive the digital video and control signals over UTP cable or cables 306. Typically, it has a HDMI or DVI (depending on the targeted applications) connector 304 as a video and control signals input and output port, and multiple RJ45 UTP connectors 307 as the video and control signals output and input ports.

The UTP cable or cables 306 are usually one or two CAT-5, CAT-6, CAT-7 or other special UTP cable/cables.

The receiver 313 based on the present invention includes the drivers/receivers and/or signal converters needed to transmit and receive the digital video and control signals over UTP cable or cables 311. Typically, it has one or two RJ45 UTP connector/connectors 312 as video and control signals input and output ports, and a HDMI or DVI (depending on the targeted applications) connector 314 as a video and control signals input and output port.

The proper cable 315 matches the video port on the display 317 and the video port on the receiver 313. Typically, it is a straight HDMI cable, straight DVI cable, HDMI to DVI adapter cable, or DVI to HDMI adapter cable.

The display 317 is to display the video. Typically, it is a HDTV, including LCD TV, Plasma TV, and DLP TV, or computer monitor, including LCD display and other flat-panel displays.

The distributor 309 based on the present invention includes the drivers and receivers and/or signal converters needed to receive and transmit video and control signals over UTP cables 306 to multiple receivers 313. Also, it may include a decoder and encoder for the video and control signals so it can re-generate the proper video and control signals. Typically it has one or two RJ45 UTP connectors 308 to connect to the transmitter (3) and multiple of RJ45 UTP connectors 310 to connect to the multiple receivers 313.

What is claimed is:

1. A method of using UTP cable or cables to extend uncompressed digital video from a source to one or more display(s) through HDMI or DVI ports.

2. The method of claim 1 wherein said UTP cable or cables are CAT-5, CAT-6, CAT-7 and special unshielded twisted pair cables.

3. The method of claim 1 wherein said UTP cable or cables can be one cable or two cables.

4. The method of claim 1 wherein said extend is to carry the original digital signals in their original electrical signaling format, or in different formats that completely represent the original signals, or a combination of both.

5. The method of claim 1 wherein said video source includes the video generated by a computer, DVD player, HD DVD player, Blu-ray player, cable TV set-top box or satellite TV set-top box.

6. The method of claim 1 wherein said display(s) include LCD TV, Plasma TV, DPL TV or LCD computer monitors with HDMI or DVI ports.

7. The method of claim 1 wherein said extend is to carry the original digital signals over longer distances than what HDMI or DVI cables are capable of.

8. The method of claim 1 wherein said extend is to distribute the source signals to one or more display(s).

9. The method of claim 8 wherein said distribute can be one source to one display or one source to multiple displays.

10. The method of claim 8 wherein said distribute can be one source directly to multiple displays or one source indirectly to multiple displays through one or multiple distributors.
